(19) United States
(12) Patent Application Publication
(10) Pub. No.: US 2007/0086605 A1
(43) Pub. Date: Apr. 19, 2007

(54) Electro-acoustic transducer comprising an rfid circuit

(75) Inventor: Heimo Scheucher, Langegg (AT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/579,421

(22) PCT Filed: Nov. 12, 2004
(86) PCT No.: PCT/IB04/52402

§ 371 Date: May 11, 2006

(30) Foreign Application Priority Data
Nov. 14, 2003 (EP) 03104197.3

(51) Int. Cl. H04R 3/00

(52) U.S. Cl. 381/111; 381/116

(57) ABSTRACT

In an electro-acoustic transducer (1), there are provided sound-generating means (38) of an annular form that surround an interior space (22), in which interior space (22) is housed an integrated circuit (31) by means of which a communication circuit (31B) of an RFID communication partner device (37) is formed.

The invention relates to an electro-acoustic transducer having sound-generating means and having a circuit unit, which circuit unit has a circuit substrate and at least one circuit component of a signal-processing circuit, which circuit component is mounted on the circuit substrate.

An electro-acoustic transducer of the kind specified in the first paragraph above is known from patent document U.S. Pat. No. 6,243,472 B1. In the known transducer, a plurality of circuit components are provided on a carrier of the circuit unit, which carrier is in the form of a plate, said circuit components forming a transducer circuit that is used to process and act on signals that are to be fed and are fed to the sound-generating means. In connection with a transducer of this kind having a transducer circuit incorporated in the transducer, reference may be made to the international patent application having the application number PCT/IB03/03275, of 18 Jul. 2003 (PHAT020049 EP-P). In the known electro-acoustic transducers, the at least one circuit component forms a transducer circuit, which gives advantages in respect of the processing of the acoustic signal but, on the other hand, constitutes a limitation because a transducer of this kind is often used in devices in which additional functionalities are provided for which a known transducer does not provide any support.

It is an object of the invention to remove the limitation identified above and to produce an improved electro-acoustic transducer.

To achieve the object stated above, features in accordance with the invention are provided in an electro-acoustic transducer in accordance with the invention, thus enabling an electro-acoustic transducer in accordance with the invention to be characterized in the manner specified below, namely:

An electro-acoustic transducer having sound-generating means and having a circuit unit, which circuit unit has a circuit substrate and at least one circuit component of a signal-processing circuit, which circuit component is mounted on the circuit substrate, wherein the sound-generating means are annular in form and surround an interior space, which interior space is accessible from outside the sound-generating means when the transducer is being manufactured and before the circuit unit is fitted, and wherein the at least one circuit component is arranged in the interior space in the sound-generating means and forms a communication circuit of a communication partner device for contactless communication.

What is achieved by the making of the provisions in accordance with the invention is above all that an electro-acoustic transducer intended for an electro-acoustic device can, in addition, be used to produce a communication partner device belonging to this electro-acoustic device, which is of advantage for a solution that is as inexpensive and space-saving as possible and requires the smallest possible number of assembly steps. The provision of the features in accordance with the invention makes it possible, in a structurally simple way, to obtain a particularly space-saving design of electro-acoustic transducer having a inbuilt communication circuit of a communication partner device, because the at least one circuit component of the communication circuit, which component is mounted on the circuit substrate, is housed within the interior space in the sound-generating means and therefore does not take up any additional space.

In an electro-acoustic transducer in accordance with the invention, a plurality of discrete circuit components may be provided on the circuit substrate to form a communication circuit. A communication circuit of this kind may also be produced by thin-film technology. It has however proved to be highly advantageous if only a single circuit component is provided that is formed by an integrated circuit connected to the circuit substrate, which integrated circuit forms the communication circuit. A particularly small and space-saving solution can be obtained in this way.

In an embodiment having an integrated circuit, it has further proved to be highly advantageous if, in addition, the features claimed in claim 3 are provided. This means that the moving coil is advantageously used for two purposes. A solution of this kind is also advantageous in that it allows the electrically conductive connection between the moving coil and the communication circuit to be of a form that is as simple as possible.

In an electro-acoustic transducer in accordance with the invention, in which the sound-generating means have a diaphragm, connecting contacts that extend in parallel to one another may be provided in point or strip form on a face of the circuit substrate that is remote from the diaphragm. It has however proved to be highly advantageous if four connecting contacts, each in the form of a sector of a circular annulus, are provided on a face of the circuit substrate remote from the diaphragm. An embodiment of this kind has been found to be particularly advantageous in practice.

The circuit unit may, for example, be fastened in place by means of at least one screw. It has however proved to be highly advantageous if the circuit unit is arranged to be removable without the use of a separate tool. For this purpose, a latching connection or a bayonet-type connection may be provided between the circuit unit and another component part of the transducer. It is also possible for a press-fit of greater or lesser tightness to be provided between the circuit unit and another component part of the transducer.

These and other aspects of the invention are apparent from and will be elucidated with reference to the embodiments described hereinafter, to which however the invention is not limited.

In the drawings:

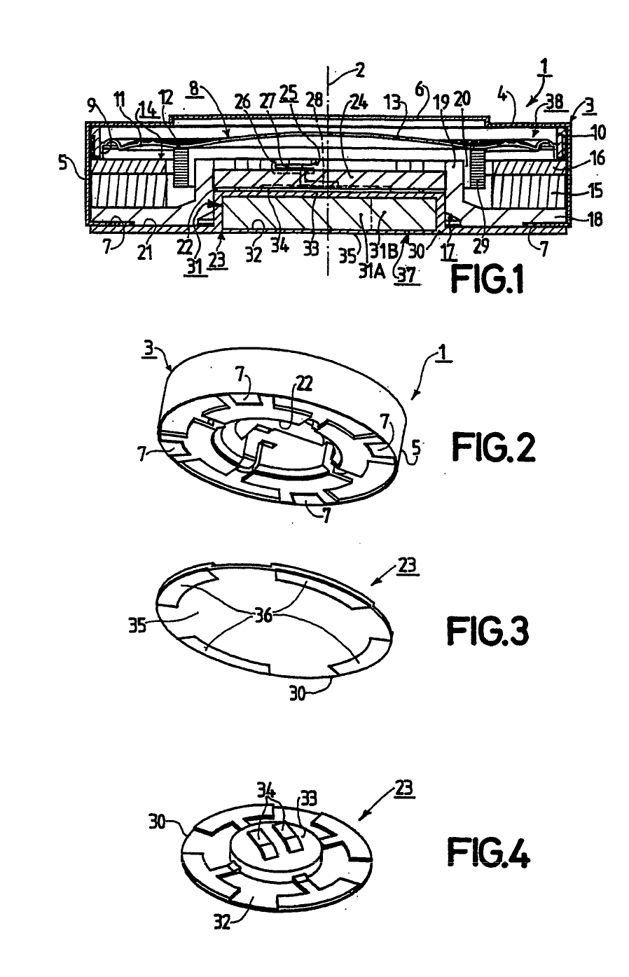

FIG. 1 shows in a cross-section an electro-acoustic transducer according to one embodiment of the invention, which transducer is provided with a circuit unit.

FIG. 2 shows in an oblique view from the rear the transducer according to FIG. 1, without the circuit unit.

FIG. 3 shows in an oblique view from the rear the circuit unit of the transducer according to FIG. 1.

FIG. 4 shows in an oblique view from the front the circuit unit of the transducer according to FIG. 1.

FIG. 1 shows an electro-acoustic transducer 1, which is a loudspeaker 1 in the present case. The transducer 1 is of a form that is substantially symmetrical about its center and it has a transducer axis 2.

The transducer 1 has a housing 3 of a cup-like form that is composed of metal 30 and that has an end-wall 4 and a side-wall 5, the end-wall 4 being provided with a circular raised portion 6 in which are provided openings (not shown) for the passage of sound, and there being four tabs 7, in the form of strips, that project from the side-wall 5 and extend in radial directions towards the transducer axis 2, by means of which tabs 7 the component parts of the transducer 1 that are housed in the housing 3 are secured in their axial positions. It is also possible for more than four such tabs 7 to be provided. The radial positions of the component parts of the transducer 1 that are housed in the housing 3 are fixed with the help of the side-wall 5. The height of the cup-like housing 3 in the direction in which the transducer axis 2 is oriented and in the region thereof is 3.2 mm. The diameter of the housing 3 in directions extending perpendicularly to the transducer axis 2 is 13.2 mm. The transducer 1 is thus a transducer that is of a particularly small form. The transducer 1 is intended for use in, for example, a mobile telephone and similar telecommunication devices, which devices are intended to be particularly small in form, which means that the components used in them, such as the transducer 1, also need to be particularly small in form and to take up only a small amount of space. Consequently, it is advantageous for a transducer 1 of this kind if its dimensions are smaller than those of known transducers even by only a few tenths of a millimeter.

The transducer 1 contains a diaphragm 8 that is substantially U-shaped in its edge region 9, the U-shaped edge region 9 being connected to a ring 10, which ring 10 is connected to the diaphragm 8 when the diaphragm 8 is being manufactured and which ring 10 is used for transport purposes and also for assembly purposes. When the transducer 1 is being manufactured, the ring 10 plus the diaphragm 8 connected thereto is slid into the housing 3 parallel to the direction of the transducer axis 2, the tabs 7 not yet having been bent over of course but extending in a direction substantially parallel to the transducer axis 2. The diaphragm 8 has an intermediate region 11 that connects up with the U-shaped edge region 9, an annular fastening region 12 that connects up with the intermediate region 11 and a central region 13 that is situated inside the fastening region 12, which central region 13 is used to generate sound. For this purpose, the diaphragm 8 as a whole is arranged to be capable of oscillating parallel to the transducer axis 2.

The transducer 1 also has a magnet system 14. The magnet system comprises a permanent magnet 15, a first yoke 16 that is in the form of a circular annulus and rests flat against the permanent magnet 15, and a second yoke 17 of L-shaped configuration in cross-section, of which second yoke 17 a first portion 18 of disc shape likewise rests flat against the permanent magnet 15 and a second portion 19 in the firm of a hollow cylinder projects from the-first portion 18 in a direction-parallel to the transducer axis 2; When the transducer 1 is being manufactured, the first yoke 16, then the permanent magnet 15 and then the second yoke 17 are slid into the housing 3 parallel to the direction of the transducer axis 2. Once the three parts 16, 15 and 17 of the magnet system have been slid into place, the tabs 7 on the housing 3 are bent over to the positions shown in FIGS. 1 and 2, as a result of which the diaphragm 8 and the magnet system 14 are then fixed in place. Between the free end of the second portion 19 of the second yoke 17 and the inner edge of the first yoke 16 is formed an air-gap 20 that is defined by the two parts of the magnet system, namely the first yoke 16 and the second yoke 17. The magnet system 14 has a boundary face 21 that is situated on the side remote from the diaphragm 8 and that forms the outside boundary of the magnet system 14, which boundary face 21 is formed by a face, in the form of a circular annulus, of the first portion 18 of the second yoke 17.

The magnet system 14, a moving coil 29 and the diaphragm 8 form sound-generating means 38 of the transducer 1.

As can be seen from FIGS. 1 and 2, the magnet system 14 is advantageously annular in form in the present case. Consequently, the sound-generating means 38 too are annular in form. The magnet system 14 surrounds an interior space 22, which interior space 22 is accessible, when the transducer 1 is being manufactured and before a circuit unit 23 is fitted (details of the form of which latter will be given below), from outside the magnet system 14 over the whole of its extent in directions lying perpendicular to the transducer axis 2 and has the transducer axis 2 passing through it In the present case, the annular form of the magnet system 14 and the sound-generating means 38 is defined as a circular annulus. The annular form may however also be of elliptical, rectangular or square configuration.

Firmly held in the interior space 22 is a contact carrier 24, which contact carrier 24 is composed of plastics material and is intended to hold two moving-coil contacts 25, of which moving-coil contacts 25 only one, 25, can be seen in FIG. 1 due to the fact that the view is in cross-section. The moving-coil contacts 25 are connected to the contact carrier 24 by being molded into it. Each moving-coil contact 25 has a U-shaped portion 26, between the two side-members of which is clamped one end 27 of a moving-coil wire. Each moving-coil contact 25 has an L-shaped portion 28 that projects from one side-member of the U-shaped portion 26.

The transducer 1 contains a moving coil 29, which moving coil 29 is arranged partly in the air-gap 20 and is connected to the diaphragm 8 in the latter's fastening region 12 by means of an adhesive-bonded joint (not shown). The moving coil 29 cooperates with the magnet system 14, there being fed to the moving coil 29 an electrical signal that represents a signal to be reproduced acoustically, as a result of which the moving coil 29 is caused to oscillate and the diaphragm 8 produces the signal that is to be reproduced acoustically. The electrical signal fed to the moving coil 29 has to be amplified, and may also need to have its signal waveform acted on if required, before it is fed to the moving coil 29. What is required for this is a transducer circuit 31A that is arranged to perform the requisite actions on the signal, in particular to amplify it.

In the transducer 17 this transducer circuit 31A is connected directly to the transducer 1. For this purpose, the circuit unit 23 that has already been mentioned is provided in the transducer 1. The circuit unit 23 has a circuit substrate 30 of plate-like form, which circuit substrate 30 is arranged to be adjacent the boundary face 21 of the annular magnet system 14 in the axial direction. Provided and mounted on the circuit substrate 30 of plate-like form in the present case is only a single circuit component 31, which is formed by an integrated circuit 31 connected to the circuit substrate 30, which integrated circuit 31 is only schematically indicated in FIG. 1 and which integrated circuit 31 forms the transducer circuit 31A and, in addition, a communication circuit 31B of a communication partner device 37, which communication partner device 37 will be considered in greater detail below. The integrated circuit 31 is advantageously arranged on that face 32 of the circuit substrate 30 that is adjacent the diaphragm 8 in this case. This produces a state of affairs where the integrated circuit 31 is arranged in the interior space 22 in the magnet system 14, which gives the major advantage that the space that is available anyway in the interior space 22 is exploited to house the integrated circuit 31, which means that no additional space is required to house the integrated circuit 31, which is advantageous to obtain a height for the transducer 1, including the transducer circuit 31A and the communication circuit 31B, that is as small as possible. The integrated circuit 31 is embedded in a substantially cup-shaped plastics encapsulation 33. Projecting from the plastics encapsulation 33 are two connecting contacts 34 that are connected to the plastics encapsulation by being molded into it, each of which connecting contacts 34 has an electrically conductive connection to a moving-coil contact 25, the electrically conductive connection being made in each case between a connecting contact 34 and an L-shaped portion 28 of a moving-coil contact 25. Each of the two connecting contacts 34 is connected to a terminal (not shown) of the integrated circuit 31. The circuit substrate 30 is formed by a small printed-circuit board in this case, to which the plastics encapsulation 33 is connected. The circuit substrate 30 and the plastics encapsulation 33 may however also be all in one piece, in which case the circuit substrate 30 too will then be composed of plastics material, thus giving a particularly simple and advantageous embodiment.

As can be seen from FIG. 3, there are provided on that face 35 of the circuit substrate 30 that is remote from the diaphragm 8 four contact terminals 36 that are each in the form of a sector of a circular annulus. Two of these contact terminals 36 are used to feed in the electrical signal that is to be reproduced as an acoustic signal. Another two of these contact terminals 36 are used to feed in a d.c. supply voltage for the integrated circuit 31, which d.c. supply voltage is always fed to the transducer circuit 31A and, depending on the mode in which the communication circuit 31B is operating, possibly to the communication circuit 31B as well.

With regard to the communication circuit 31B and the communication partner device 37 containing the communication circuit 31B, it should be mentioned that a communication partner device 37 of this kind and a communication circuit 31B of this kind have long been known. They are communication means that enable communication to be carried on between a read/write station and what is termed a transponder, by which communication firstly data stored in the transponder can be transmitted to the read/write station and secondly data contained in the read/write station can be transmitted to the transponder. In connection with a communication partner device 37 of this kind, attention may be drawn to certain patent documents, namely to, for example U.S. Pat. No. 5,345,231, EP 0 473 569 B2, EP 0 669 591 B1, U.S. Pat. No. 6,168,083 B1, EP 0 783 740 B1, U.S. Pat. No. 6,563,882 B1, U.S. Pat. No. 6,510,149 B1, U.S. Pat. No. 6,583,717 B1, U.S. Pat. No. 6,442,215 B1, EP 1 038 257 B1, EP 1 064 616 131, U.S. Pat. No. 6,301;138 B1, WO 02/51021 A1 and WO 02/51183 A1, and to certain standards, namely to, for example ISO 14443, ISO 15693, ISO 18000 and ISO 18092. The contents of the above-mentioned patent documents and standards is hereby incorporated by reference. As can be seen from the last two patent documents mentioned, it is known for communication partner devices having a transponder function and/or a read/write station function to be provided in a portable telephone, i.e. a portable device for communication by radio. However, it has, to date, only been known for the communication circuit of the communication partner device to be provided as a separate component, or to be provided as a separate component on a replaceable component, such as a battery, for the portable device for communication by radio. By contrast, in the solution described by reference to FIGS. 1 to 4, the communication circuit 31B of the communication partner device 37 is provided inside the electro-acoustic transducer 1, which electro-acoustic transducer 1 is provided and arranged in a portable device for communication by radio, but also in other electro-acoustic devices (PDAs, pagers). This solution gives the advantage that no additional space whatsoever is required for the communication circuit 31B of a communication-partner device 37. In the case of the solution shown in FIGS. 1 to 4, the additional advantage is obtained in this case that the communication circuit 31B is implemented jointly with the transducer circuit 31A by means of a single integrated circuit 31, which is also advantageous to give costs that are as low as possible.

In the present case, the communication partner device 37 is implemented by means of the communication circuit 31B and by means of the moving coil 29, which moving coil 29 is at the same time used as a transmission means for contactless communication. By means of the contactless transmission means formed by the moving coil 29, contactless transmission of data becomes possible between the communication circuit 31B of the communication partner device 37, which communication circuit 31B is housed in the transducer 1, and a read/write device (not shown), i.e. a further communication partner device.

It should be mentioned that, rather than using the moving coil 29 as, in addition, a contactless transmission means, a solution may also be provided in which the communication circuit 31B is connected to a communication coil that is provided in addition to the moving coil 29. A solution of this kind gives the advantage that the separate communication coil can be sized with a greater degree of independence of the dimensions of the electro-acoustic transducer 1, by which means better conditions of transmission can possibly be obtained.

In the present case, the circuit unit 23 is secured in place by a latching connection (not shown in the Figures). This latching connection is made between the contact carrier 24 and the plastics encapsulation 33. The latching connection may however also be provided between other component parts of the transducer 1, such as, for example, between the second yoke 17 and the circuit substrate 30. Because the circuit unit 23 is secured in place by means of a latching connection, the circuit unit 23 can be removed from the rest of the transducer 1 without the need for a separate tool. The circuit unit 23 is thus designed to be removable without a separate tool. The circuit unit 23 may however also be secured in place by means of an easily releasable snap-action connection or bayonet-type connection. The circuit unit 23 may also be secured in place by means of, for example, adhesive-bonded joints or welded joints at localized points.

What is achieved in a particularly advantageous fashion with the transducer 1 is firstly that only a very small amount of additional space is required in the direction in which the transducer axis 2 is oriented to accommodate the integrated circuit 31, namely the amount of space-required for the plate-like circuit substrate 30, which however amounts to only a few tenths of a millimeter, and is secondly that the circuit unit 23 is easily and simply accessible even after the transducer 1 has been completed and can be replaced easily and simply in the event of its failing to operate satisfactorily.

In a modified version of the transducer 1 shown in FIGS. 1 to 4, the circuit substrate provided is not one that extends to the side-wall 5 of the housing 3 and instead the outside diameter of the circuit substrate 30 is only the same as the inside diameter of the interior space 22 and the height of the space occupied by the plastics encapsulation 33 plus the circuit substrate 30 is only such that that face 35 of the circuit substrate 30 that is remote from the diaphragm 8 lies flush with the boundary face 21 of the magnet system or is even in a position where it is slightly offset from the boundary face 21 in the axial direction into the interior space, which means that in this case too the circuit substrate 30 is arranged to be adjacent the boundary face 21 of the magnet system 14, that is to say adjacent substantially in radial directions. As a result of this, no additional space whatsoever is required in the direction in which the transducer axis 2 is oriented to accommodate the circuit unit 23 containing the integrated circuit 31. In this modified version of the transducer 1, the circuit substrate 30 may be formed by a bottom wall of the plastics encapsulation 33.

With regard to the circuit unit 23, it should also be mentioned that the circuit unit 23 is of a surface-mountable form and can thus be connected to a printed-circuit board of a mobile telephone or of a similar device by an SMD process. The circuit unit 23 thus forms a surface-mountable adapter for the transducer 1, in which case the said adapter may or may not be connected to the rest of the transducer 1 depending on the customer's wishes or the application.

It should also be mentioned that an intermediate layer, that is designed to provide particularly good thermal transmission between the circuit substrate 30 and the second yoke 17 of the magnet system 14, may also be provided between that boundary face 21 of the magnet system 14 that is remote from the diaphragm 8 and that face 32 of the circuit substrate 30 that is adjacent the diaphragm 8.

With regard to the transducer 1, it should also be mentioned that it is equally possible for a circuit unit 23 not to be provided in the transducer 1, i.e. for a transducer 1 without a circuit unit 23 of this kind to be supplied to a customer for fitting into a mobile telephone or a similar device, in which case a transducer 1 of this kind that has been supplied without a circuit unit 23 will then have to be supplied with the electrical signal that is to be reproduced acoustically from a transducer circuit that is external to the transducer 1, this external transducer circuit being connected directly to the L-shaped portions 28 of the two moving-coil contacts 25.

The transducer circuit 31A and the communication circuit 31B may also be formed by two separate integrated circuits. The communication circuit 31B may contain both a transponder circuit and a read/write station circuit, as is the case in so-called NFC systems to which standard ISO 18092 relates. In a so-called NFC transponder of this kind, the transmission of data is possible not only unidirectionally in respective opposing directions but also bidirectionally.

Where the transducer 1 is used in a mobile telephone, the communication circuit 31B of the transducer 1 may also be connected via additional contacts to a processor belonging to the mobile telephone (which may or may not have a cryptography unit) to enable not only acoustic signals to be transmitted via the communication circuit 31B but also text and image data to be transmitted to, for example, a display of the mobile telephone.

It may be mentioned that the electro-acoustic transducer in accordance with the invention may also be a microphone. An electro-acoustic transducer in accordance with the invention may also take the form of a piezoelectric transducer. In this case so-called MEMS technology may be employed, by which a piezo loudspeaker and/or a piezo microphone are implemented on an IC.

By means of the communication circuit 31B, incoming or outgoing signals (data) may also be respectively decrypted and encrypted, thus making it possible for communication secure against listening-in to take place via the communication circuit 31B. Before a communication, the partners involved in the communication must exchange the relevant keys (RSA, DES, triple DES, elliptic curve, etc.) to enable communication secure against listening-in to take place. This may be very helpful and indeed necessary particularly in the case of transactions involving money.

Code storage may also be performed by means of the communication circuit 31B, which means that, as an option, special tuning data for, for example, loudspeaker adjustment could be stored on the relevant chip (such as an NFC chip, for example) for, for example, adjusting frequencies (treble frequencies, bass frequencies) to enable the loudspeaker to be tuned via an amplifier. Provision could also be made for codeword and/or number codes to be input via an input microphone and a downstream speech pattern recognition means.

In the case of a mobile telephone, the possibility also exists of providing, in addition to a transducer in accordance with the invention having an inbuilt communication circuit 31B, a further, additional, electro-acoustic transducer that is contained in a headset, for example, and has a special encryption unit (fixed or variable), in which case data can then be transmitted from the mobile telephone to the headset by means of the inbuilt communication circuit 31B contactlessly (or else via a cable) and in encrypted form and the data can be decrypted by means of a further communication circuit provided in the headset, which means that the decrypted data, and consequently signals, will only become available directly in the ear, as a result of which the data transmitted will be particularly secure against listening-in because in this case it will only be the data or signals that are transmitted in encrypted form that can be listened in on.

1. An electro-acoustic transducer having sound-generating means and having a circuit unit, which circuit unit has a circuit substrate and at least one circuit component of a signal-processing circuit, which circuit component is mounted on the circuit substrate wherein the sound-generating means are annular in form and surround an interior space which interior space His accessible from outside the sound-generating means when the transducer is being manufactured and before the circuit unit is fitted, and wherein the at least one circuit component is arranged in the interior space in the sound-generating means and forms a communication circuit of a communication partner device for contactless communication.

2. An electro-acoustic transducer as claimed in claim 1, wherein only a single circuit component is provided that is formed by an integrated circuit connected to the circuit substrate which integrated circuit forms the communication circuit.

3. An electro-acoustic transducer as claimed in claim 1, wherein the integrated circuit is embedded in a plastics encapsulation wherein two connecting contacts each of which is connected to a moving-coil contact of a moving coil belonging to the sound-generating means, are provided on the plastics encapsulation, and wherein the moving coil is intended and used, in addition, as a contactless transmission means of the communication partner device.

4. An electro-acoustic transducer as claimed in claim 1, wherein the sound-generating means have a diaphragm, and wherein four contact terminals each in the form of a sector of a circular annulus, are provided on a face of the circuit substrate that is remote from the diaphragm.

5. An electro-acoustic transducer as claimed in claim 1, wherein the circuit unit is arranged to be removable without the use of a separate tool.

6. An electro-acoustic transducer as claimed in claim 1, wherein the transducer has a cup-shaped housing whose height in the direction in which a transducer axis is oriented is between 2 and 5 mm and whose diameter perpendicular to the direction in which the transducer axis is oriented is between 6 and 20 mm.
